(19) United States
(12) Patent Application Publication
(10) Pub. No.: US 2026/0118722 A1
(43) Pub. Date: Apr. 30, 2026

(54) LIQUID CRYSTAL DEVICE AND ELECTRONIC APPARATUS

(71) Applicant: SEIKO EPSON CORPORATION, Tokyo (JP)

(72) Inventor: Hiroyuki ABE, MATSUMOTO-SHI (JP)

(73) Assignee: SEIKO EPSON CORPORATION, Tokyo (JP)

(21) Appl. No.: 19/372,254

(22) Filed: Oct. 28, 2025

(30) Foreign Application Priority Data
Oct. 30, 2024 (JP) 2024-190974

(51) Int. Cl. G02F 1/1343; G03B 21/00

(52) U.S. Cl. CPC G02F 1/13439; G03B 21/006

(57) ABSTRACT

A liquid crystal device includes a common electrode to which a common potential is applied, a pixel electrode to which a signal potential is applied and which is disposed in a display region, a first electrode to which a first potential having a positive polarity with respect to the common potential is applied and which is disposed outside the display region in plan view, a second electrode to which a second potential having a negative polarity with respect to the common potential is applied and which is disposed outside the display region in plan view, and a liquid crystal layer disposed between the pixel electrode and the common electrode, between the first electrode and the common electrode, and between the second electrode and the common electrode.

The present application is based on, and claims priority from JP Application Serial Number 2024-190974, filed Oct. 30, 2024, the disclosure of which is hereby incorporated by reference herein in its entirety.

### BACKGROUND

### 1. Technical Field

The present disclosure relates to a liquid crystal device and an electronic apparatus.

### 2. Related Art

In a liquid crystal device, there is a possibility that a photochemical reaction occurs in a liquid crystal layer in a display region due to irradiation with illumination light, and impurities formed from ionic substances are desorbed from a vapor-deposited film of the liquid crystal. The impurities desorbed from the vapor-deposited film may move within the display region along the oblique direction of the vapor-deposited film, which is deposited obliquely on the substrate, and accumulate at the corner portions of the display region in plan view, thereby forming display spots. The display quality of the liquid crystal device may deteriorate due to impurities moving in the display region or impurities accumulated in the corner portion of the display region.

In the related art, measures for suppressing deterioration in the display quality of the liquid crystal device and improving reliability by capturing the impurities generated in the display region in a peripheral region outside the display region have been studied. For example, in the liquid crystal device disclosed in JP-A-2018-180428, a fixed potential different from the counter electrode potential applied to the counter electrode is applied to a first peripheral electrode disposed in the peripheral region around the first corner portion disposed diagonally along a direction intersecting one axial direction in the pixel region among peripheral electrodes disposed in the peripheral region around the pixel region in which a plurality of pixel electrodes are disposed. In the liquid crystal device disclosed in JP-A-2018-180428, a fixed potential smaller than the fixed potential applied to the first peripheral electrode may be applied to a second peripheral electrode disposed in the peripheral region around the second corner portion disposed diagonally along the one axial direction.

JP-A-2018-180428 is an example of the related art.

It has been confirmed that the impurities generated in the display region, as described above, are formed from ionic substances and contain impurities having a positive polarity and impurities having a negative polarity. In the liquid crystal device disclosed in JP-A-2018-180428, even when a fixed potential corresponding to impurities having one of the positive polarity and the negative polarity is applied to the first peripheral electrode and the second peripheral electrode, the amount of impurities captured in the display region is insufficient, the deterioration of display quality cannot be suppressed, and the reliability may deteriorate. Therefore, it is desired to take measures to remove the impurities from the display region based on the polarity of the impurities to enhance the display quality and reliability of the liquid crystal device.

### SUMMARY

A liquid crystal device according to an aspect of the present disclosure includes: a common electrode to which a common potential is applied, a pixel electrode to which a signal potential is applied and which is disposed in a display region, a first electrode to which a first potential having a positive polarity with respect to the common potential is applied and which is disposed outside the display region in plan view, a second electrode to which a second potential having a negative polarity with respect to the common potential is applied and which is disposed outside the display region in plan view, and a liquid crystal layer disposed between the pixel electrode and the common electrode, between the first electrode and the common electrode, and between the second electrode and the common electrode. In plan view, the first electrode includes a first portion and a second portion whose distance from the display region is longer than that of the first portion. In plan view, the second electrode is disposed between the display region and the second portion.

### BRIEF DESCRIPTION OF THE DRAWINGS

FIG. 1 is a plan view of a liquid crystal device according to a first embodiment.

FIG. 2 is a cross-sectional view of the liquid crystal device of FIG. 1 taken along line II-II.

FIG. 3 is a cross-sectional view of the liquid crystal device of FIG. 1 taken along line III-III.

FIG. 4 is an equivalent circuit diagram of a pixel circuit in a pixel region of the liquid crystal device of FIG. 1.

FIG. 5 is an enlarged plan view of a region RV of the liquid crystal device of FIG. 1.

FIG. 6 is a schematic diagram of a projector according to a first embodiment.

FIG. 7 is a plan view of a liquid crystal device according to a second embodiment.

### DESCRIPTION OF EMBODIMENTS

Hereinafter, a liquid crystal device will be described as an example of an electro-optical device according to the embodiment. In the following drawings, dimensions and scales of parts are appropriately different from those of an actual device. The embodiments described below are preferred specific examples. Unless otherwise stated in the following description, the scope of the present disclosure is not limited to the embodiments described below.

### First Embodiment

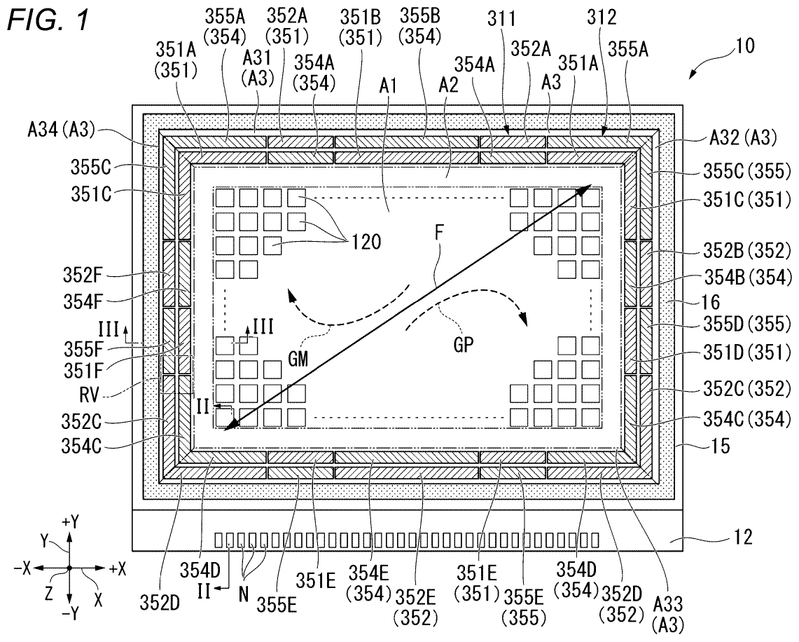

A first embodiment of the present disclosure will first be described with reference to FIGS. 1 to 5.

### Liquid Crystal Device

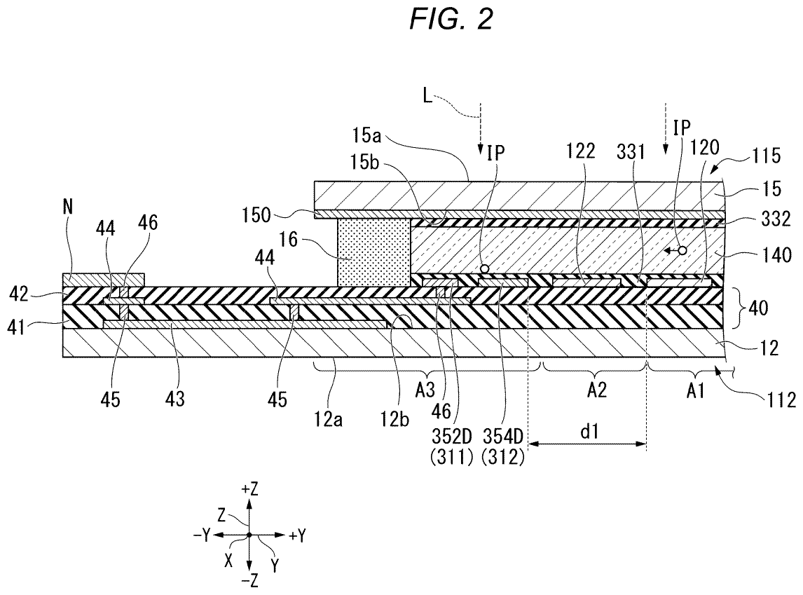

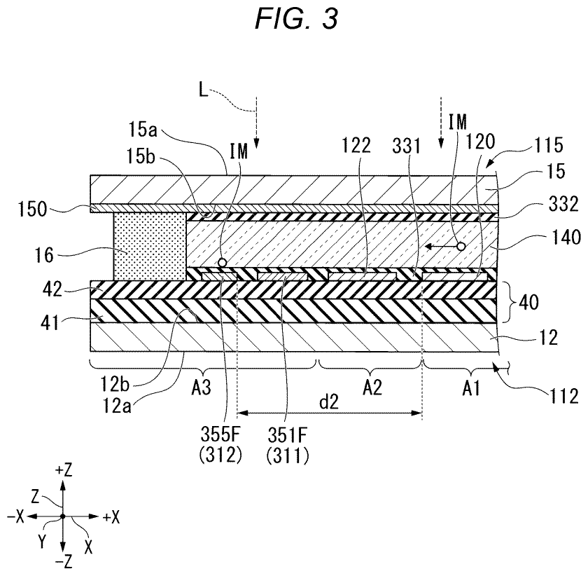

The liquid crystal device 10 of the first embodiment is an electro-optical device and a liquid crystal display device including a liquid crystal element that converts incident color light into image light. FIG. 1 is a plan view of the liquid crystal device 10. FIG. 2 is a cross-sectional view of the liquid crystal device 10 of FIG. 1 taken along line II-II. FIG. 3 is a cross-sectional view of the liquid crystal device 10 of FIG. 1 taken along line III-III.

As illustrated in FIGS. 1 to 3, the liquid crystal device 10 includes a first substrate 112, a second substrate 115, a liquid crystal layer 140, and a sealing material 16. The first substrate 112 includes an element substrate 12, a plurality of pixel electrodes 120, a plurality of dummy pixel electrodes 122, a first peripheral electrode 311, a second peripheral electrode 312, a plurality of terminals N, and an alignment film 331. The second substrate 115 includes a counter substrate 15, a counter electrode 150, and an alignment film 332.

The element substrate 12 has a rectangular shape in plan view, for example, an oblong shape, and has plate surfaces 12a and 12b. The counter substrate 15 has a rectangular shape in plan view, for example, an oblong shape, and has plate surfaces 15a and 15b. The long sides of the plate surfaces 15a and 15b of the counter substrate 15 have the same length as the long sides of the plate surfaces 12a and 12b of the element substrate 12. The short sides of the plate surfaces 15a and 15b of the counter substrate 15 are shorter than the short sides of the plate surfaces 12a and 12b of the element substrate 12.

In the following description and the drawings, the X direction is one direction within the plate surfaces 12a of the element substrate 12 and 15a of the counter substrate 15, and is, for example, a direction parallel to the long side directions of the plate surfaces 12a and 15a. One side along the X direction is described as a+X side, and the other side along the X direction is described as a−X side. The Y direction is orthogonal to the X direction, is one direction within the plate surface 12a of the element substrate 12 and the plate surface 15a of the counter substrate 15, and is, for example, a direction parallel to the short side directions of the plate surface 12a and the plate surface 15a. One side along the Y direction is described as a+Y side, and the other side along the Y direction is described as a−Y side. The Z direction is orthogonal to the X direction and the Y direction, and is parallel to, for example, a direction along the thicknesses of the element substrate 12 and the counter substrate 15. One side along the Z direction is described as a+Z side, and the other side along the Z direction is described as a−Z side. The plan view means viewing along the Z direction.

The plate surface 12b of the element substrate 12 is parallel to the XY plane including the X direction and the Y direction, and is a plate surface on the +Z side among the plate surfaces 12a and 12b. A scanning line driving circuit, a data signal output circuit, a transistor functioning as a switching element, and the like (not illustrated) are formed on the element substrate 12. A wiring layer 40 is formed on the plate surface 12a of the element substrate 12. In the wiring layer 40, a first wiring layer 43, a first insulating layer 41, a first contact plug 45, a second insulating layer 42, a second wiring layer 44, and a second contact plug 46 are stacked in this order from the element substrate 12 side.

The plate surface 15b of the counter substrate 15 is parallel to the XY plane and is a plate surface on the −Z side among the plate surfaces 15a and 15b. In the liquid crystal device 10, the plate surface 12b of the element substrate 12 and the plate surface 15b of the counter substrate 15 face each other in the Z direction, and the first substrate 112 and the second substrate 115 are separated from each other at an appropriate interval. In the liquid crystal device 10, the first substrate 112 and the second substrate 115 are bonded to each other via the sealing material 16 such that the distance between the plate surface 12a of the element substrate 12 and the plate surface 15a of the counter substrate 15 in the Z direction, that is, the entire thickness in the Z direction is substantially constant.

In plan view, the liquid crystal device 10 is partitioned into a pixel region A1 including the center in the XY plane, a dummy pixel region A2 surrounding the pixel region A1 and located outside the pixel region A1, and a peripheral region A3 surrounding the dummy pixel region A2 and located further outside the dummy pixel region A2. The pixel region A1 corresponds to a display region described later and a display region of a liquid crystal device described in the claims.

In plan view, the pixel region A1 has a rectangular shape, specifically, an oblong shape having long sides parallel to the X direction and short sides parallel to the Y direction. The dummy pixel region A2 and the peripheral region A3 are partitioned into a rectangular frame shape along with the oblong shape of the pixel region A1.

The plurality of pixel electrodes 120, the plurality of dummy pixel electrodes 122, the first peripheral electrode 311, and the second peripheral electrode 312 are formed on the plate surface 12a of the element substrate 12. The plurality of pixel electrodes 120 are disposed in the pixel region A1, and are disposed in a matrix pattern at appropriate intervals along the X direction and the Y direction in the pixel region A1.

The plurality of dummy pixel electrodes 122 are disposed in the dummy pixel region A2. The dummy pixel region A2 is partitioned in a frame shape in plan view. The plurality of dummy pixel electrodes 122 have the same shape and size as the plurality of pixel electrodes 120 in plan view, and are disposed in a matrix pattern at appropriate intervals in the same manner as the plurality of pixel electrodes 120 along the X direction and the Y direction. In FIG. 1, the plurality of dummy pixel electrodes 122 are omitted.

In the liquid crystal device 10, since the dummy pixel region A2 is partitioned and the plurality of dummy pixel electrodes 122 are disposed in the dummy pixel region A2, there is no difference in the electrode structure and the relative arrangement in the vicinity of the boundary between the pixel region A1 and the dummy pixel region A2, and the occurrence of display unevenness and deterioration of display quality in the outer peripheral end portion of the pixel region A1 in plan view is suppressed. In other words, when the plurality of dummy pixel electrodes 122 having the same shape and size as the plurality of pixel electrodes 120 in plan view are not present at all for the dummy pixel electrode 122, the electrode structure and the relative arrangement may suddenly change in the vicinity of the boundary between the pixel region A1 and the dummy pixel region A2, and display unevenness may occur at the outer peripheral end portion of the pixel region A1 in plan view, or display quality may deteriorate.

When the influence of the deterioration of the display quality described above is small, the dummy pixel region A2 may be omitted, and a region corresponding to the dummy pixel region A2 may be within the pixel region A1.

The first peripheral electrode 311 is disposed in a part of the peripheral region A3. The peripheral region A3 is partitioned into a frame shape in plan view, and includes a region A31 on the +Y side parallel to the X direction, a region A32 on the +X side parallel to the Y direction, a region A33 on the −Y side parallel to the X direction, and a region A34 on the −X side parallel to the Y direction. The first peripheral electrode 311 corresponds to a first electrode described later and a first electrode of a liquid crystal device described in the claims. The first peripheral electrode 311 is disposed, for example, so as to alternately change the position in the width direction of the peripheral region A3 between two different positions for each desired length along the circumferential direction of the peripheral region A3.

The second peripheral electrode 312 is disposed in a part of the peripheral region A3 that does not overlap the region where the first peripheral electrode 311 is disposed. The second peripheral electrode 312 corresponds to a second electrode described later and a second electrode of the liquid crystal device described in the claims. The second peripheral electrode 312 is disposed, for example, so as to alternately change the position in the width direction of the peripheral region A3 between two different positions for each desired length along the circumferential direction of the peripheral region A3. The relative arrangement of the first peripheral electrode 311 and the second peripheral electrode 312 will be described later.

The pixel electrode 120, the dummy pixel electrode 122, the first peripheral electrode 311, and the second peripheral electrode 312 are made of a transparent conductive material that transmits the color light L in the visible wavelength band incident from the +Z side, and are formed of, for example, indium tin oxide (ITO) formed by the same process.

The counter electrode 150 is formed on the entire plate surface 15b of the counter substrate 15. The counter electrode 150 is made of a transparent conductive material corresponding to light incident from the +Z side, and is formed of, for example, ITO.

The first substrate 112 and the second substrate 115 are bonded to each other in the Z direction as described above, and the portion of the first substrate 112 on the −Y side of the element substrate 12 extends further to the −Y side than the counter substrate 15. The plurality of terminals N are formed on the plate surface 12b of the element substrate 12 extending further to the-Y side than the counter substrate 15. The plurality of terminals N input various electric signals to the scanning line driving circuit and the data signal output circuit.

The alignment films 331 and 332 are disposed in the pixel region A1, the dummy pixel region A2, and the peripheral region A3 on the inner peripheral side of the sealing material 16 in plan view. The alignment film 331 covers, from the +Z side, each of the following: the plurality of pixel electrodes 120, the plurality of dummy pixel electrodes 122, the first peripheral electrode 311, the second peripheral electrode 312, and the plate surface 12b of the element substrate 12 on which no electrode is formed. The +Z side surface of the alignment film 331 is parallel to the XY plane and is substantially flat.

The alignment film 332 is formed on the −Z side surface of the counter electrode 150 and covers the counter electrode 150 from the −Z side. The −Z side surface of the alignment film 332 is parallel to the XY plane and is substantially flat. The alignment films 331 and 332 determine the alignment of the liquid crystal molecules within the liquid crystal layer 140, and, for example, incline them slightly at an angle with respect to the Z direction in a non-applied voltage state.

The dummy pixel region A2 and the peripheral region A3 do not contribute to image display. For example, a light-shielding film (not illustrated) may be formed on the plate surface 15a of the counter substrate 15 in the dummy pixel region A2 and the peripheral region A3.

The liquid crystal layer 140 is disposed between the plate surface 12a of the element substrate 12 and the plate surface 15a of the counter substrate 15, and is interposed, in the Z direction, between the counter electrode 150 and each of the following: the plurality of pixel electrodes 120, the plurality of dummy pixel electrodes 122, the first peripheral electrode 311, and the second peripheral electrode 312. Specifically, the liquid crystal layer 140 is sandwiched between the alignment films 331 and 332 in the Z direction.

The liquid crystal layer 140 is surrounded by the sealing material 16 in plan view, and is sealed by the sealing material 16 in the XY plane. The liquid crystal layer 140 is a layer formed of liquid crystal molecules whose major axis direction is substantially parallel to the Z direction in a non-applied voltage state, for example, as in a vertical alignment (VA) mode.

The sealing material 16 is disposed in the peripheral region A3, is disposed outside at least the first peripheral electrode 311 and the second peripheral electrode 312, and is preferably disposed in the outermost peripheral region of the peripheral region A3.

Next, the relative arrangement of the first peripheral electrode 311 and the second peripheral electrode 312 in the peripheral region A3 will be described.

As illustrated in FIGS. 1 to 3, the first peripheral electrode 311 is partitioned into a first electrode portion 351, a second electrode portion 352, and a third electrode portion 353. The first electrode portion 351 corresponds to a first portion described later and corresponds to a first portion of the first electrode in the liquid crystal device described in the claims. The second electrode portion 352 corresponds to a second portion described later and corresponds to a second portion of the first electrode in the liquid crystal device described in the claims. The third electrode portion 353 is omitted in FIG. 1. The third electrode portion 353 corresponds to a third portion described later, and corresponds to a third portion of the first electrode in the liquid crystal device described in the claims.

As described above, the electrode portions 351 and 352 of the first peripheral electrode 311 are disposed so as to be alternately switched between two positions different from each other in the width direction of the peripheral region A3, that is, in the region on the inner peripheral side and the region on the outer peripheral side in plan view, for each desired length along the circumferential direction of the peripheral region A3. The electrode portion 351 is disposed in the region on the inner peripheral side, in plan view, of the two regions within the peripheral region A3. The electrode portion 352 is disposed in a region on the outer peripheral side, in plan view, of the two regions of the peripheral region A3. As will be described later, one end portion of the electrode portion 351 in the length direction is coupled to the other end portion of the electrode portion 352 adjacent in the length direction by the electrode portion 353. That is, the electrode portions 351, 352, and 353 of the first peripheral electrode 311 are coupled in the circumferential direction of the peripheral region A3.

The second peripheral electrode 312 is partitioned into a first electrode portion 354 and a second electrode portion 355. The first electrode portion 354 corresponds to a fourth portion described later and corresponds to a fourth portion of the second electrode in the liquid crystal device described in the claims. The second electrode portion 355 corresponds to a fifth portion described later, and corresponds to a fifth portion of the second electrode in the liquid crystal device described in the claims.

As described above, the electrode portions 354 and 355 of the second peripheral electrode 312 are alternately disposed between two different positions in the width direction of the peripheral region A3 for each desired length along the circumferential direction of the peripheral region A3. Similarly to the electrode portion 351, the electrode portion 354 is disposed in a region on the inner peripheral side, in plan view, of the two regions described above in the width direction of the peripheral region A3. Similarly to the electrode portion 352, the electrode portion 355 is disposed in a region on the outer peripheral side, in plan view, of the two regions described above in the width direction of the peripheral region A3.

In plan view, the region on the inner peripheral side of the peripheral region A3 is located at the distance d1 from the pixel electrode 120 on the outermost peripheral side of the pixel region A1. That is, the minimum distance between the outer peripheral end of the pixel electrode 120 on the outermost peripheral side of the pixel region A1 and the inner peripheral end of the region on the inner peripheral side of the peripheral region A3 is the distance d1. In the region on the inner peripheral side of the peripheral region A3, the electrode portions 351 of the first peripheral electrode 311 and the electrode portions 354 of the second peripheral electrode 312 are alternately disposed along the circumferential direction via the fine liquid crystal layer 140 or an insulating layer omitted in FIG. 1.

In plan view, the region on the outer peripheral side of the peripheral region A3 is located at the distance d2 from the pixel electrode 120 on the outermost peripheral side of the pixel region A1. That is, the minimum distance between the outer peripheral end of the pixel electrode 120 on the outermost peripheral side of the pixel region A1 and the inner peripheral end of the region on the inner peripheral side in the width direction of the peripheral region A3 is the distance d2. The distance d2 is longer than the distance d1. In the region on the outer peripheral side of the peripheral region A3, the electrode portions 352 of the first peripheral electrode 311 and the electrode portions 355 of the second peripheral electrode 312 are alternately disposed along the circumferential direction via the fine liquid crystal layer 140 or the insulating layer omitted in FIG. 1.

For example, in the region A31 of the peripheral region A3, the length direction corresponds to the X direction, and the width direction corresponds to the Y direction. In the region on the inner peripheral side of the region A31, the first electrode portion 351A of the first peripheral electrode 311, the first electrode portion 354A of the second peripheral electrode 312, the first electrode portion 351B, the electrode portion 354A, and the electrode portion 351A are sequentially disposed along the X direction between the end on the −X side and the end on the +X side. The length of the electrode portion 351A in the X direction is longer than the length of the electrode portion 354A in the X direction. The length of the electrode portion 351B in the X direction is longer than the length of the electrode portion 351A in the X direction.

In the region on the outer peripheral side of the region A31, the second electrode portion 355A of the second peripheral electrode 312, the second electrode portion 352A of the first peripheral electrode 311, the second electrode portion 355B, the electrode portion 352A, and the electrode portion 355A are sequentially disposed along the X direction between the end on the −X side and the end on the +X side. The length of the electrode portion 355A in the X direction is longer than the length of the electrode portion 352A in the X direction, and is slightly longer than the length of the electrode portion 351A in the X direction, with its relationship of facing the corner portion of the pixel region A1. The length of the electrode portion 352A in the X direction is equal to the length of the electrode portion 354A in the X direction. The length of the electrode portion 355B in the X direction is equal to the length of the electrode portion 351B in the X direction.

In the region A32 of the peripheral region A3, the length direction corresponds to the Y direction, and the width direction corresponds to the X direction. In the region on the inner peripheral side of the region A32, the first electrode portion 351C of the first peripheral electrode 311, the first electrode portion 354B of the second peripheral electrode 312, the first electrode portion 351D, and the first electrode portion 354 C are sequentially disposed along the Y direction between the end on the +Y side and the end on the −Y side. The length of the electrode portion 351C in the Y direction is longer than the length of the electrode portion 354A in the X direction and the length of the electrode portion 354B in the Y direction, and is substantially equal to the length of the electrode portion 351D in the Y direction. The length of the electrode portion 354C in the Y direction is longer than the length of the electrode portion 354B in the Y direction.

In the region on the outer peripheral side of the region A32, the second electrode portion 355C of the second peripheral electrode 312, the second electrode portion 352B of the first peripheral electrode 311, the second electrode portion 355D, and the second electrode portion 352 C are sequentially disposed along the Y direction between the end on the +Y side and the end on the −Y side. The length of the electrode portion 352C in the Y direction is longer than the length of the electrode portion 355B in the Y direction, and is slightly longer than the length of the electrode portion 351C in the Y direction, with its relationship of facing the corner portion of pixel region A1. The length of the electrode portion 355B in the Y direction is equal to the length of the electrode portion 354B and is substantially equal to the length of the electrode portion 352A in the Y direction. The length of the electrode portion 355D in the Y direction is equal to the length of the electrode portion 351D. The length of the electrode portion 355C in the Y direction is longer than the length of the electrode portion 355B in the Y direction, and is slightly longer than the length of the electrode portion 351C in the Y direction, with its relationship facing the corner portion of the pixel region A1.

In the region A33 of the peripheral region A3, the length direction corresponds to the X direction, and the width direction corresponds to the Y direction. In the region on the inner peripheral side of the region A33, the first electrode portion 354D of the second peripheral electrode 312, the first electrode portion 351E of the first peripheral electrode 311, the first electrode portion 354E, the electrode portion 351E, and the electrode portion 354D are sequentially disposed along the X direction between the end on the +X side and the end on the −X side. The length of the electrode portion 354D in the X direction is longer than the length of the electrode portion 351E in the X direction and is substantially equal to the length of the electrode portion 354C in the Y direction. The length of the electrode portion 351E in the X direction is substantially equal to each of the lengths of the electrode portions 351A and 354A in the X direction. The length of the electrode portion 354E in the X direction is substantially equal to each of the lengths of the electrode portions 351B and 354B in the X direction.

In the region on the outer peripheral side of the region A33, the second electrode portion 352D of the first peripheral electrode 311, the second electrode portion 355E of the second peripheral electrode 312, the second electrode portion 352E, the electrode portion 355E, and the electrode portion 352D are sequentially disposed along the X direction between the end on the +X side and the end on the −X side. The length of the electrode portion 352D in the X direction is equal to the length of the electrode portion 352C in the Y direction. The length of the electrode portion 355E in the X direction is equal to the length of the electrode portion 351E in the X direction. The length of the electrode portion 352E in the X direction is equal to the length of the electrode portion 354E in the X direction.

In the region A34 of the peripheral region A3, the length direction corresponds to the Y direction, and the width direction corresponds to the X direction. In the region on the inner peripheral side of the region A34, the electrode portion 354C of the second peripheral electrode 312, the first electrode portion 351F of the first peripheral electrode 311, the first electrode portion 354F, and the electrode portion 351C are sequentially disposed along the Y direction between the end on the-Y side and the end on the +Y side. The length of the electrode portion 351F in the Y direction is equal to the length of the electrode portion 354B in the Y direction. The length of the electrode portion 354F in the Y direction is equal to the length of the electrode portion 351D in the Y direction.

In the region on the outer peripheral side of the region A34, the electrode portion 352C of the first peripheral electrode 311, the second electrode portion 355F of the second peripheral electrode 312, the second electrode portion 353F, and the electrode portion 355C are sequentially disposed along the Y direction between the end on the −Y side and the end on the +Y side. The length of the electrode portion 355F in the Y direction is equal to the length of the electrode portion 351F in the Y direction. The length of the electrode portion 352F in the Y direction is equal to the length of the electrode portion 354F in the Y direction.

In plan view, the electrode portions 351A and 351C of the first electrode portion 351 of the first peripheral electrode 311 face the corner portion on the +X side and +Y side of the pixel region A1, and the corner portion on the −X side and +Y side of the pixel region A1. The +X side end of the electrode portion 351A disposed on the +X side and the +Y side end of the electrode portion 351C disposed on the +X side are coupled to each other. The −X side end of the electrode portion 351A disposed on the −X side and the +Y side end of the electrode portion 351C disposed on the −X side are coupled to each other.

In plan view, the electrode portions 354C and 354D of the first electrode portion 354 of the second peripheral electrode 312 face the corner portion on the +X side and the −Y side of the pixel region A1 and the corner portion on the −X side and the −Y side of the pixel region A1. The −Y side end of the electrode portion 354C disposed on the +X side and the +X side end of the electrode portion 354D disposed on the +X side are coupled to each other. The −Y side end of the electrode portion 354C disposed on the −X side and the −X side end of the electrode portion 354D disposed on the −X side are coupled to each other.

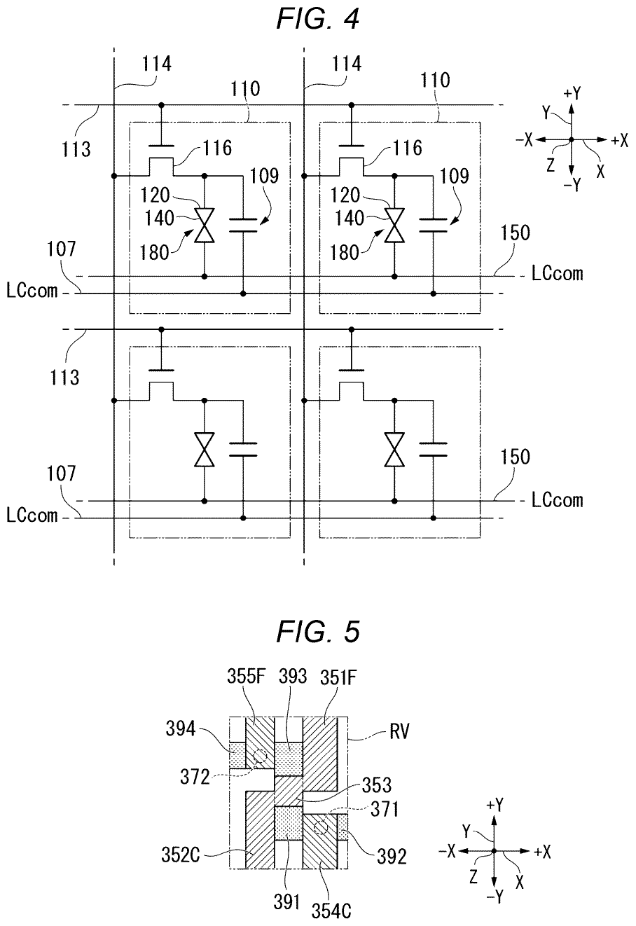

FIG. 4 is an equivalent circuit diagram of the pixel circuit 110 formed in the pixel region A1. As illustrated in FIG. 4, the pixel circuit 110 is provided corresponding to intersection positions of a plurality of scanning lines 113 extending in the X direction and a plurality of data lines 114 extending in the Y direction. The pixel circuit 110 includes a transistor 116 functioning as a switching element and a liquid crystal element 180.

The transistor 116 is, for example, an N-channel thin film transistor (TFT). In the pixel circuit 110, the gate node of the transistor 116 is coupled to the scanning line 113, the source node of the transistor 116 is coupled to the data line 114, and the drain node of the transistor 116 is coupled to the pixel electrode 120.

In the description in the present specification, “coupling” means direct or indirect coupling or bonding between two or more elements. In the description in this specification, “coupled” includes, for example, a state in which two or more elements are coupled to each other on a substrate and a state in which two or more elements are bonded to each other via different conductive layers and contact plugs.

The counter electrode 150 faces the plurality of pixel electrodes 120 and is maintained at a substantially constant potential LCcom over time. A predetermined potential LCsig different from the potential LCcom is applied to each of the plurality of pixel electrodes 120. The potential LCcom corresponds to a common potential described later and a common potential in the liquid crystal device described in the claims. The potential LCsig corresponds to a signal potential described later and a signal potential in the liquid crystal device described in the claims. In each of the plurality of pixel circuits 110, the liquid crystal element 180 is formed by the pixel electrode 120, the counter electrode 150, and the liquid crystal layer 140.

A storage capacitor 109 is provided electrically in parallel to the liquid crystal element 180. One end of the storage capacitor 109 is coupled to the pixel electrode 120, and the other end of the storage capacitor 109 is coupled to a capacitance line 107. The capacitance line 107 is maintained at a constant potential over time, for example, the same potential LCcom as the counter electrode 150.

The scanning line driving circuit sequentially and exclusively selects the plurality of scanning lines 113 one by one in one frame period, and sets the scanning signal of the selected scanning line 113 to a relatively high H level. The data signal output circuit outputs a data signal having a potential corresponding to a gradation to the pixel circuit 110 located on the scanning line 113 selected by the scanning line driving circuit via the data line 114.

In the pixel circuit 110 corresponding to the scanning line 113 in which the scanning signal is at the H level, since the transistor 116 enters the on state, the data signal is applied to the pixel electrode 120 via the data line 114. Even when the scanning signal becomes a relatively low L level and the transistor 116 enters the off state, the data signal is held by the capacitance of the liquid crystal element 180 and the storage capacitor 109.

In the liquid crystal element 180, the orientation of the liquid crystal molecules changes in accordance with an electric field generated by the pixel electrode 120 and the counter electrode 150. The transmittance of the liquid crystal element 180 with respect to the color light L incident on the liquid crystal element 180 changes according to the effective value of the voltage applied to the liquid crystal element 180.

The above-described operation and behavior are similarly executed in the pixel circuit 110 coupled to the selected scanning line 113. By sequentially and exclusively selecting the scanning lines 113 in one frame period, the transmittances of all the liquid crystal elements 180 in the pixel region A1 change according to the gradation. As a result, an image in one frame period is generated, and the color light L is converted into image light (not illustrated).

The liquid crystal element 180 operates in a normally black mode, for example. In the normally black mode, the transmittance of the liquid crystal element 180 is the lowest when the voltage applied to the liquid crystal element 180 is zero, and the transmittance of the liquid crystal element 180 increases as the applied voltage increases.

The liquid crystal element 180 is driven by direct current or alternating current. Specifically, when the liquid crystal element 180 is driven by alternating current, the potential of the data signal is a potential having a positive polarity on the higher side or a potential having a negative polarity on the lower side with respect to the potential LCcom of the counter electrode 150, and is alternately switched between the potential having a positive polarity and the potential having a negative polarity, for example, for each frame period.

The first peripheral electrode 311 is maintained at a potential LC1 different from the potential LCcom of the counter electrode 150 at least while the scanning signal is at the H level. The potential LC1 has a positive polarity with respect to the potential LCcom, or to a potential having a positive polarity on the higher side referenced to the potential LCcom. The potential LC1 corresponds to a first potential described later, and corresponds to a first potential in the liquid crystal device described in the claims. The potential LC1 is applied to the first peripheral electrode 311 from, for example, a common wiring (not illustrated) which is not electrically coupled to each of the scanning line 113 and the data line 114 in the first substrate 112.

The second peripheral electrode 312 is maintained at a potential LC2 different from the potential LCcom of the counter electrode 150 and the potential LC1 of the first peripheral electrode 311 at least while the scanning signal is at the H level. The potential LC2 has a negative polarity with respect to the potential LCcom or a potential having a negative polarity on the lower side referenced to the potential LCcom. The potential LC2 corresponds to a second potential described later, and corresponds to a second potential in the liquid crystal device described in the claims.

The potential LC2 is applied to the second peripheral electrode 312 from, for example, another common wiring which is not electrically coupled to each of the scanning line 113, the data line 114, and the common wiring which applies the potential LC1 to the first peripheral electrode 311 in the first substrate 112.

As illustrated in FIG. 2, the distance d1 between the inner peripheral region of the peripheral region A3 and the pixel region A1 in plan view corresponds to the distance between the first electrode portion 354D of the second peripheral electrode 312 and the pixel electrode 120. Strictly speaking, the distance between the electrode portion 354D of the second peripheral electrode 312 and the pixel region A1 is the shortest distance, in the XY plane, between the inner peripheral end of the first electrode portion 354 including the electrode portion 354D of the second peripheral electrode 312, and the outer peripheral end of one of the pixel electrodes 120, which is disposed on the outer peripheral side among the plurality of pixel electrodes 120 and faces the first peripheral electrode 311.

As shown in FIG. 2, the first insulating layer 41 includes the first contact plug 45 for electrically coupling the first wiring layer 43 and the second wiring layer 44. The second insulating layer 42 includes the second contact plug 46 for electrically coupling the second wiring layer 44 and the first peripheral electrode 311, the second wiring layer 44 and the second peripheral electrode 312, and the second wiring layer 44 and the pixel electrode 120. The first peripheral electrode 311 is electrically coupled to the terminal N via the first insulating layer 41, the second insulating layer 42, the first wiring layer 43, the second wiring layer 44, the first contact plug 45, and the second contact plug 46. Similarly, the second peripheral electrode 312 is also electrically coupled to the terminal N via the first insulating layer 41, the second insulating layer 42, the first wiring layer 43, the second wiring layer 44, the first contact plug 45, and the second contact plug 46.

When an appropriate potential is applied to each electrode of the liquid crystal device 10, color light L is incident along the Z direction from the +Z side of the plate surface 15a of the counter substrate 15 of the second substrate 115 in the pixel region A1, and as the conversion of the color light L into image light proceeds, the impurities IM and IP formed from ionic substances are generated in the liquid crystal layer 140. The impurities IM are formed from ionic substances having a negative polarity. The impurities IM generated from the liquid crystal layer 140 in the pixel region A1 are captured by the first peripheral electrode 311 having a positive polarity, and are captured by, for example, the second electrode portion 352F.

The impurities IP are formed from ionic substances having a positive polarity. The moving speed of the impurities IP on the XY plane is faster than the moving speed of the impurities IM on the XY plane. The impurities IP generated from the liquid crystal layer 140 in the pixel region A1 are captured by the second peripheral electrode 312 having a negative polarity, and are captured by, for example, the first electrode portion 354F.

As illustrated in FIG. 3, the distance d2 between the outer peripheral region of the peripheral region A3 and the pixel region A1 in plan view corresponds to the distance between the second electrode portion 355F of the second peripheral electrode 312 and the pixel electrode 120. Strictly speaking, the distance between the electrode portion 355F of the second peripheral electrode 312 and the pixel region A1 is the shortest distance, in the XY plane, between the inner peripheral end of the second peripheral electrode 312 and the outer peripheral end of one of the pixel electrodes 120, which is disposed on the outer peripheral side among the plurality of pixel electrodes 120 and faces the second peripheral electrode 312.

The length of each of the first electrode portion 351 and the second electrode portion 352 of the first peripheral electrode 311, and the first electrode portion 354 and the second electrode portion 355 of the second peripheral electrode 312 in the peripheral region A3 is appropriately set in accordance with the moving direction and the moving speed of the impurities IM and IP generated from the liquid crystal layer 140 in the pixel region A1 in plan view as exemplified later. For example, it is assumed that the impurities IM generated from the liquid crystal layer 140 tend to accumulate at the corner portion on the +X side and the +Y side of the pixel region A1 and are actively captured by the electrode portions 351A and 351C disposed on the +X side.

The length in the X direction of the electrode portion 354A having a negative polarity adjacent in the X direction to the electrode portion 351A having a positive polarity disposed on the +X side is about ⅓ of the length in the X direction of the electrode portion 351A disposed on the +X side. Similarly, the length in the Y direction of the electrode portion 354B having a negative polarity adjacent in the Y direction to the electrode portion 351C having a positive polarity disposed on the +X side is about ⅓ of the length in the Y direction of the electrode portion 351C disposed on the +X side.

In the above-described case, it is also assumed that the impurities IM generated from the liquid crystal layer 140 also tend to accumulate at the corner portion on the −X side and the +Y side of the pixel region A1 and are captured by the electrode portions 351A and 351C disposed on the −X side. The length in the X direction of the electrode portion 354A having a negative polarity adjacent in the X direction to the electrode portion 351A having a positive polarity disposed on the-X side in the X direction is about ⅓ of the length in the X direction of the electrode portion 351A disposed on the −X side. Similarly, the length in the Y direction of the electrode portion 354F having a negative polarity adjacent to the electrode portion 351C having a positive polarity disposed on the −X side in the Y direction is about ⅓ of the length in the Y direction of the electrode portion 351C disposed on the −X side.

For example, it is assumed that the impurities IP generated from the liquid crystal layer 140 tend to accumulate at the corner portion on the −X side and the-Y side, which is diagonal to the corner portion on the +X side and the +Y side in plan view in the pixel region A1, and are actively captured by the electrode portions 354D and 354C disposed on the −X side. The length in the X direction of the electrode portion 351E having a positive polarity adjacent in the X direction to the electrode portion 354D having a negative polarity disposed on the −X side in the X direction is about ⅓ of the length of the electrode portion 354D disposed on the −X side. Similarly, the length in the Y direction of the electrode portion 351F having a positive polarity adjacent in the Y direction to the electrode portion 354C having a negative polarity disposed on the −X side in the Y direction is about ⅓ of the length in the Y direction of the electrode portion 354C disposed on the −X side.

For example, it is assumed that the impurities IP generated from the liquid crystal layer 140 tend to accumulate at the corner portion on the −X side and the −Y side of the pixel region A1 and are actively captured by the electrode portions 354D and 354C disposed on the −X side. The length in the X direction of the electrode portion 351E having a positive polarity adjacent in the X direction to the electrode portion 354D having a negative polarity disposed on the −X side in the X direction is about ⅓ of the length of the electrode portion 354D disposed on the −X side. Similarly, the length in the Y direction of the electrode portion 351F having a positive polarity adjacent in the Y direction to the electrode portion 354C having a negative polarity disposed on the −X side in the Y direction is about ⅓ of the length in the Y direction of the electrode portion 354C disposed on the −X side.

In the above-described case, it is also assumed that the impurities IP generated from the liquid crystal layer 140 also tend to accumulate at the corner portion on the +X side and the −Y side of the pixel region A1 and are captured by the electrode portions 354D and 354C disposed on the +X side. The length in the X direction of the electrode portion 351E having a positive polarity adjacent in the X direction to the electrode portion 354D having a negative polarity disposed on the +X side is about ⅓ of the length of the electrode portion 354D disposed on the +X side. Similarly, the length in the Y direction of the electrode portion 351D having a positive polarity adjacent in the Y direction to the electrode portion 354C having a negative polarity disposed on the +X side is about ⅓ of the length in the Y direction of the electrode portion 354C disposed on the +X side.

FIG. 5 is an enlarged view of a region RV shown in FIG. 1. As illustrated in FIG. 5, the size in the X direction, that is, the width dimension of the first electrode portion 351F of the first peripheral electrode 311 is larger than the size in the X direction, that is, the width dimension of the first electrode portion 355F of the second peripheral electrode 312 facing the electrode portion 351F in the X direction. The size in the X direction, that is, the width dimension of the first electrode portion 354C disposed on the −X side of the second peripheral electrode 312 is larger than the size in the X direction, that is, the width dimension of the second electrode portion 352C of the first peripheral electrode 311 facing the electrode portion 354C in the X direction.

That is, in the width direction of the peripheral region A3, the first electrode portion 351 including the electrode portion 351F of the first peripheral electrode 311 and the first electrode portion 354 including the electrode portion 354C of the second peripheral electrode 312 are larger than the first electrode portion 352 including the electrode portion 352C of the first peripheral electrode 311 and the second electrode portion 355 including the electrode portion 355F of the second peripheral electrode 312.

The end portion on the −Y side of the first electrode portion 351F of the first peripheral electrode 311 and the end portion on the +Y side of the second electrode portion 352C disposed on the −X side of the first peripheral electrode 311 are coupled by the third electrode portion 353 in the X direction. That is, the end portion of the first electrode portion 351 of the first peripheral electrode 311 in the length direction is coupled to the end portion of the second electrode portion 352 of the first peripheral electrode 311 in the length direction, the end portion of which is disposed closest in the width direction, via the third electrode portion 353.

The plurality of the electrode portions 351, 352, and 353 of the first peripheral electrode 311 are coupled along the length direction and the circumferential direction of the peripheral region A3 to form a single electrode. An end on the +Z side of the contact plug (not illustrated), made of a conductive material, is coupled from the element substrate 12 on the −Z side to an appropriate one of the electrode portions 351 or 352 among the plurality of the electrode portions 351, 352, and 353 that form the first peripheral electrode 311. The −Z side end of the contact plug (not illustrated), which is coupled to an appropriate electrode portion 351 or electrode portion 352, is coupled to the common wiring or the like formed on the element substrate 12 on the −Z side.

The end portion on the +Y side of the first electrode portion 354C disposed on the −X side of the second peripheral electrode 312 and the second electrode portion 355F of the second peripheral electrode 312 are not electrically coupled in both the X direction and the Y direction. Therefore, a contact plug 371 made of a conductive material is electrically coupled to the electrode portion 354C disposed on the −X side of the second peripheral electrode 312 from the element substrate 12 on the −Z side. A contact plug 372 made of a conductive material is electrically coupled to the electrode portion 355F of the second peripheral electrode 312 from the element substrate 12 on the −Z side.

Each of the plurality of the first electrode portions 354 including the electrode portion 354C of the second peripheral electrode 312 is electrically coupled to the end on the +Z side of the contact plug made of a conductive material similarly to the contact plug 371 from the element substrate 12 on the −Z side. Each of the plurality of second electrode portions 355 including the electrode portion 355F of the second peripheral electrode 312 is electrically coupled to the end on the +Z side of the contact plug made of a conductive material similarly to the contact plug 372 from the element substrate 12 on the −Z side. Each −Z side end of each of the contact plugs 371 and 372 and the contact plugs coupled to the electrode portions 354 and 355 is coupled to wiring different from the common wiring to which the contact plug (not illustrated), coupled to an appropriate one of the electrode portions 351 or 352, is coupled.

In the Y direction, the distance between the +Y side end of the electrode portion 354C disposed on the −X side and the −Y side end of the electrode portion 353 coupling the electrode portions 351F and 352C is shorter than the distance between the +Y side end of the electrode portion 354C disposed on the −X side and the −Y side end of the electrode portion 351 F. An insulating layer 391 is disposed between the electrode portion 354C and the electrode portion 352C disposed on the −X side in the X direction. Since the insulating layer 391 is interposed between the electrode portion 354C disposed on the −X side and the electrode portion 353 coupling the electrode portions 351F and 352C in the Y direction, the electrode portion 354 C disposed on the −X side is reliably insulated from the electrode portion 353 coupling the electrode portions 351 F and 352 C.

An insulating layer 392 is disposed on the +X side relative to the +Y side end of the electrode portion 354C disposed on the −X side, and on the −X side relative to the pixel region A1. The insulating layer 392 substantially overlaps the insulating layer 391 in the Y direction. The contact plug 371 is within a region where the insulating layers 391 and 392 are disposed in the Y direction.

In the Y direction, the distance between the −Y side end of the electrode portion 355F and the +Y side end of the electrode portion 353 coupling the electrode portions 351F and 352C is shorter than the distance between the −Y side end of the electrode portion 355F and the +Y side end of the electrode portion 352 C disposed on the −X side. An insulating layer 393 is disposed between the electrode portion 353F and the electrode portion 351F in the X direction. Since the insulating layer 383 is interposed between the electrode portion 355F and the electrode portion 353 coupling the electrode portions 351F and 352C in the Y direction, the electrode portion 355F is also reliably insulated from the electrode portion 353 coupling the electrode portions 351F and 352C.

An insulating layer 394 is disposed on the −X side relative to the −Y side end of the electrode portion 355F, and on the +X side relative to the sealing material 16 disposed in region A34 of the peripheral region A3. The insulating layer 394 substantially overlaps the insulating layer 393 in the Y direction. The contact plug 372 is within a region where the insulating layers 393 and 394 are disposed in the Y direction.

When an appropriate potential is applied to each electrode of the liquid crystal device 10, the color light L is incident along the Z direction from the +Z side of the plate surface 15a of the counter substrate 15 of the second substrate 115 in the pixel region A1, and the conversion of the color light L into the image light proceeds, the impurities IM and IP are generated in the liquid crystal layer 140. The impurities IM generated from the liquid crystal layer 140 in the pixel region A1 are captured by, for example, the first electrode portion 351F of the first peripheral electrode 311. The impurities IP generated from the liquid crystal layer 140 in the pixel region A1 are captured by, for example, the first electrode portion 355F of the second peripheral electrode 312.

In the liquid crystal device 10, as described above, the impurities IM generated in the liquid crystal layer 140 in the pixel region A1 are captured by the first peripheral electrode 311 in the energized state, and the impurities IP generated in the liquid crystal layer 140 in the pixel region A1 are captured by the second peripheral electrode 312 in the energized state. From these points, the formation of display spots or the like at the outer peripheral end of the pixel region A1 can be prevented, and the decrease in the amount of image light emitted from the pixel region A1 can be suppressed. As a result, the display quality and reliability of the liquid crystal device 10 are improved.

Each of the potentials LC1 and LC2 is a direct-current potential or an alternating-current potential, and is preferably a direct-current potential. Since each of the potentials LC1 and LC2 is a direct-current potential, the capturing effect of the impurities IM in the first peripheral electrode 311 in the energized state and the capturing effect of the impurities IP in the second peripheral electrode 312 in the energized state are stabilized.

However, when each of the potentials LC1 and LC2 is an alternating-current potential, and the positive polarity and the negative polarity of the potential LC1 with respect to the potential LCcom are alternately switched at a predetermined time cycle, the capturing effect of the first peripheral electrode 311 in the energized state on the impurities IM and the capturing effect of the second peripheral electrode 312 in the energized state on the impurities IP are switched at each cycle time. Similarly, when the negative polarity and the positive polarity of the potential LC2 with respect to the potential LCcom are alternately switched at a predetermined time cycle, the capturing effect of the second peripheral electrode 312 in the energized state on the impurities IP and the capturing effect on the impurities IM are switched at each cycle time.

The first peripheral electrode 311 and the second peripheral electrode 312 are not electrically coupled to each other and are not coupled to each other in the XY plane. The length along the circumferential direction in the peripheral region A3 of each of the first electrode portions 351A to 351F and the second electrode portions 352A to 352F of the first peripheral electrode 311 having a positive polarity is determined in accordance with the movement direction and the moving speed of the impurities IM having a negative polarity generated in the liquid crystal layer 140 of the pixel region A1, and further in the consideration of the ratio of the impurities IM to the impurities IP generated in the liquid crystal layer 140 of the pixel region A1.

Similarly, the length along the circumferential direction in the peripheral region A3 of each of the first electrode portions 354A to 354F and the second electrode portions 355A to 355F of the second peripheral electrode 312 having a negative polarity is determined in accordance with the movement direction and the moving speed of the impurities IP having a positive polarity generated in the liquid crystal layer 140 of the pixel region A1, and further in consideration of the ratio of the impurities IM to the impurities IP generated in the liquid crystal layer 140 of the pixel region A1.

In the liquid crystal device 10, the alignment direction of the liquid crystal molecules in the liquid crystal layer 140 is determined by the ejection angle of the material of the alignment film 331 when the alignment film 331 is obliquely deposited on the +Z side surface of each of the plurality of pixel electrodes 120, the plurality of dummy pixel electrodes 122, the first peripheral electrode 311, and the second peripheral electrode 312, as well as on the plate surface 12b of the element substrate 12 on which each electrode is not formed, and by the ejection angle of the material of the alignment film 332 when the alignment film 332 is obliquely deposited on the −Z side surface of the counter electrode 150.

For example, as illustrated in FIG. 1, the liquid crystal molecules of the liquid crystal layer 140 may be aligned, in a non-applied voltage state, by the alignment films 331 and 332 in a direction from the −Y side to the +Y side as they move from the −X side to the +X side in the pixel region A1, that is, in an alignment direction F along a line coupling the vicinity of the corner portion on the +X side and +Y side of the pixel region A1 with the vicinity of the corner portion on the −X side and −Y side in plan view.

Most of the impurities IM having a negative polarity generated in the liquid crystal layer 140 of the pixel region A1 move to the corner portion on the +X side and the +Y side of the pixel region A1 along the alignment direction F, face the corner portion, and are captured by the first electrode portions 351A and 351C disposed on the −X side in the first peripheral electrode 311. At least a part of the remaining impurities IM is warped from the alignment direction F, moves as indicated by a dashed arrow GM, and moves toward the corner portion on the −X side and the +Y side of the pixel region A1 in plan view.

In the example described above, in plan view, the corner portion on the +X side and the +Y side of the pixel region A1 corresponds to a first corner portion described later and a first corner portion of the display region of the liquid crystal device described in the claims. In plan view, the corner portion on the −X side and the −Y side of the pixel region A1 is at a diagonal position with respect to a corner portion on the +X side and the +Y side, and corresponds to a second corner portion described later and a second corner portion of the display region of the liquid crystal device described in the claims.

At least a part of the remaining impurities IM passes through the dummy pixel region A2 and moves to the region A34 while moving from the −Y side to the +Y side at the outer peripheral end facing the region A34 of the peripheral region A3 in the pixel region A1 in plan view. The impurities IM moved to the region A34 are first captured by the first electrode portion 351F of the first peripheral electrode 311 and the first electrode portion 351C on the −X side.

A part of the impurities IM moving from the end on the −Y side to the end on the +Y side of the electrode portion 351F is subjected to the repulsive effect of the electrode portion 354F having a negative polarity facing the end on the +Y side of the electrode portion 351F having a positive polarity in the Y direction, and cannot move further to the +Y side, but moves to the −X side. A part of the impurities IM moving from the end on the −Y side to the end on the +Y side of the electrode portion 351C is subjected to the repulsive effect of the electrode portion 355A having a negative polarity, which faces the end on the +Y side of the electrode portion 351C having a positive polarity and is disposed on the +X side in the Y direction, cannot move further to the +Y side, and moves along the electrode portion 351A on the −X side, which is coupled to the electrode portion 351C on the −X side, toward the +X side, and is captured and accumulated.

As described above, since the impurities IM move in the X direction at the end portion on the +Y side of the electrode portion 351F and the end portion on the +Y side of the electrode portion 351C disposed on the −X side, the size in the X direction, that is, the width dimension of the electrode portion 351C is larger than the size in the X direction, that is, the width dimension of each of the electrode portion 352F and the electrode portion 352C disposed on the −X side.

The other part of the impurities IM moving to the −X side in the first electrode portion 351C and the first electrode portion 351F disposed on the −X side of the first peripheral electrode 311 passes through the electrode portion 353 and is captured and accumulated in the second electrode portion 352 C and the second electrode portion 352 F disposed on the −X side of the first peripheral electrode 311.

For example, most of the impurities IM moved to the electrode portion 352F are subjected to the repulsive effect by the electrode portion 355F from the −Y side, are subjected to the repulsive effect by the electrode portion 354F from the +X side, and are subjected to the repulsive effect by the electrode portion 355C disposed from the +Y side to the −X side. Therefore, the impurities IM captured and accumulated in the electrode portion 352F of the peripheral region A3 in the energized state are prevented from returning to the pixel region A1. When the electrode portion 352F is in the non-energized state, the captured impurities IM diffuse, but since the electrode portion 352F is disposed farther from pixel region A1 than electrode portions 351C, 351F, and 354F in plan view, the return of the impurities IM from 352F to pixel region A1 is suppressed.

As described above, the impurities IM moved from the −Y side to the end portion on the +Y side of each of the first electrode portion 351C and the first electrode portion 351F disposed on the −X side do not overflow from the electrode portions 351C and 351F in the X direction, and the return of the impurities IM from the second electrode portion 352F and the second electrode portion 352 C disposed on the −X side to the pixel region A1 is suppressed. Therefore, in the liquid crystal device 10, the occurrence of display spots and display unevenness due to the impurities IM returning to the pixel region A1 is favorably suppressed.

Most of the impurities IP having a positive polarity generated in the liquid crystal layer 140 of the pixel region A1 move to the corner portion on the −X side and the −Y side of the pixel region A1 along the alignment direction F, face the corner portion, and are captured by the first electrode portions 354C and 354D disposed on the +X side in the second peripheral electrode 312. At least a part of the remaining impurities IP is warped from the alignment direction F, moves as indicated by a dashed arrow GP, and moves toward the corner portion on the −X side and the +Y side of the pixel region A1 in plan view.

At least a part of the remaining impurities IP passes through the dummy pixel region A2 and moves to the region A32 while moving from the +Y side to the −Y side at the outer peripheral end facing the region A32 of the peripheral region A3 in the pixel region A1 in plan view. The impurities IP moved to the region A32 are first captured by the first electrode portion 354B of the second peripheral electrode 312 and the first electrode portion 354C on the −X side.

A part of the impurities IP moving from the end on the +Y side to the end on the −Y side of the electrode portion 354B is subjected to the repulsive effect of the electrode portion 351D having a positive polarity facing the end on the −Y side of the electrode portion 354B having a negative polarity in the Y direction, and cannot move further to the −Y side, but moves to the +X side. A part of the impurities IP moving from the end on the +Y side to the end on the −Y side of the electrode portion 354C is subjected to the repulsive effect of the electrode portion 352D having a positive polarity, which faces the end on the −Y side of the electrode portion 354C having a negative polarity and is disposed on the −X side in the Y direction, cannot move further to the −Y side, and moves along the electrode portion 354D on the +X side, which is coupled to the electrode portion 354C on the +X side, toward the −X side, and is captured and accumulated.

As described above, since the impurities IP move in the X direction at the end portion on the −Y side of the electrode portion 354B and the end portion on the −Y side of the electrode portion 354C disposed on the −X side, the size in the X direction, that is, the width dimension of each of the electrode portions 354B and 354C is larger than the size in the X direction, that is, the width dimension of each of the electrode portion 355D and the electrode portion 355C disposed on the +X side.

The other part of the impurities IP moving to the +X side in the first electrode portion 354B of the second peripheral electrode 312 and the first electrode portion 354C disposed on the +X side passes through the electrode portion 353 and is captured and accumulated in the second electrode portion 355C and the second electrode portion 355D disposed on the +X side of the second peripheral electrode 312.

For example, most of the impurities IP moved to the electrode portion 355D are subjected to the repulsive effect by the electrode portion 352C disposed from the −Y side to the −X side, are subjected to the repulsive effect by the electrode portion 351D from the −X side, and are subjected to the repulsive effect by the electrode portion 352B from the +Y side. Therefore, the impurities IP captured and accumulated in the electrode portion 355D of the peripheral region A3 in the energized state are prevented from returning to the pixel region A1. When the electrode portion 355D is in the non-energized state, the captured impurities IP diffuse, but since the electrode portion 355D is disposed farther from pixel region A1 than electrode portions 351D, 354B, and 354C in plan view, the return of the impurities IP from 355D to pixel region A1 is suppressed.

As described above, the impurities IP moved from the +Y side to the end portion on the −Y side of each of the first electrode portion 354B and the first electrode portion 354C disposed on the +X side do not overflow from the electrode portions 354B and 354C in the X direction, and the return of the impurities IP from the second electrode portion 355D and the second electrode portion 355C disposed on the −X side to the pixel region A1 is suppressed. Therefore, the occurrence of display spots and display unevenness due to the impurities IP returning to the pixel region A1 is favorably suppressed.

### Projector and Electronic Apparatus

Next, a projector as an example of an electronic apparatus including the liquid crystal device 10 according to the first embodiment will be described.

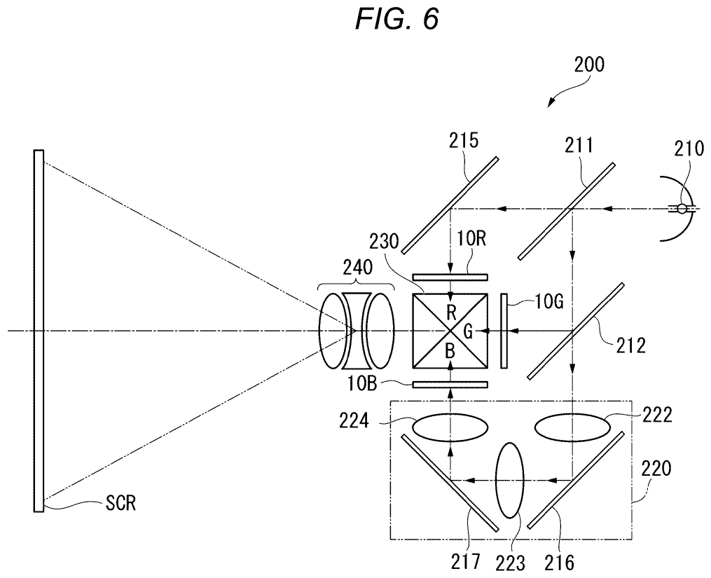

FIG. 6 is a schematic diagram of a projector 200 according to the first embodiment. As illustrated in FIG. 6, the projector 200 is a so-called three-plate projector, and includes a light source device 210, two dichroic mirrors 211 and 212, three total reflection mirrors 215, 216, and 217, three liquid crystal devices 10B, 10G, and 10R, a cross dichroic prism 230, and a projection optical system 240. Each of the liquid crystal devices 10B, 10G, and 10R is formed similarly to the liquid crystal device 10 described above.

The light source device 210 is formed of a halogen lamp or a white light emitting diode (LED), and emits white light including red light, green light, and blue light. The white light emitted from the light source device 210 is separated into red light, green light, and blue light by the dichroic mirror 211, and is separated into green light and blue light by the dichroic mirror 212.

The red light emitted from dichroic mirror 211 is reflected by the total reflection mirror 215 and then irradiates the liquid crystal device 10R. The green light emitted from the dichroic mirror 211 is emitted from the dichroic mirror 212 and irradiates the liquid crystal device 10G. The blue light emitted from the dichroic mirror 211 is reflected by the total reflection mirrors 216 and 217 and then irradiates the liquid crystal device 10b.

The optical path of the blue light from the dichroic mirror 211 to the liquid crystal device 10B is longer than the optical path of the red light from the dichroic mirror 211 to the liquid crystal device 10R and the optical path of the green light from the dichroic mirror 211 to the liquid crystal device 10G. In order to suppress the loss of the blue light with respect to the red light and the green light, an incident lens 222 is disposed on the optical path of the blue light between the dichroic mirror 212 and the total reflection mirror 216. A relay lens 223 is disposed between the total reflection mirror 216 and the total reflection mirror 217. An emission lens 224 is disposed between the total reflection mirror 217 and the liquid crystal device 10B. The relay optical system 220 is formed by the incident lens 222, the relay lens 223, and the emission lens 224.

The liquid crystal device 10R is driven based on an input image signal corresponding to the incident red light, and generates image light R including a red transmission image. The liquid crystal device 10G is driven based on an input image signal corresponding to the incident green light, and generates image light G including a green transmission image. The liquid crystal device 10B is driven based on an input image signal corresponding to the incident blue light, and generates image light B including a blue transmission image. The image lights R, G, and B are contained in the color light L described above.

The image light R emitted from the liquid crystal device 10R, the image light G emitted from the liquid crystal device 10G, and the image light B emitted from the liquid crystal device 10B are incident on a cross dichroic prism 230 from different directions in plan view. In the cross dichroic prism 230, the image lights R and B are reflected, and each optical path of the image lights R and B is refracted by 90° in plan view. In the cross dichroic prism 230, the image light G is transmitted and travels straight, and the optical path of the image light G overlaps the optical paths of the image lights R and B.

The image light combined by the cross dichroic prism 230 and emitted in a direction different from the incident directions of the image lights R, G, and B is enlarged and projected onto the screen SCR by the projection optical system 240. The projection optical system 240 includes one or more optical lenses. Examples of the optical lenses include a biconvex lens, a biconcave lens, a planoconvex lens, a meniscus lens, an aspherical lens, and a freeform lens. A color image is displayed on the screen SCR.

Examples of the electronic apparatuses including the electro optical device such as the liquid crystal device 10 include, in addition to the projector 200, an electronic viewfinder in a head-mounted display, a video camera, a lens-interchangeable digital camera, or the like, a smart watch, and a display unit of a wearable device.

### Effects and Advantages

The liquid crystal device 10 according to the first embodiment described above includes a counter electrode (common electrode) 150, a plurality of pixel electrodes 120, the first peripheral electrode (first electrode) 311, the second peripheral electrode (second electrode) 312, and the liquid crystal layer 140. The potential (common potential) LCcom is applied to the counter electrode 150. The potential (signal potential) LCsig is applied to each of the plurality of pixel electrodes 120. The plurality of pixel electrodes 120 are disposed in the pixel region (display region) A1 in plan view. The potential (first potential) LC1 having a positive polarity with respect to the potential LCcom is applied to the first peripheral electrode 311. The first peripheral electrode 311 is disposed in a part of the peripheral region A3 surrounding the pixel region A1 in plan view. The potential (second potential) LC2 having a negative polarity with respect to the potential LCcom is applied to the second peripheral electrode 312. In plan view, the second peripheral electrode 312 is disposed in a part of the peripheral region A3, and is disposed in a region different from the first peripheral electrode 311 in the peripheral region A3. The liquid crystal layer 140 is disposed between each of the plurality of pixel electrodes 120 and the counter electrode 150, between the first peripheral electrode 311 and the counter electrode 150, and between the second peripheral electrode 312 and the counter electrode 150, in the Z direction. In the liquid crystal device 10 according to the first embodiment, the first peripheral electrode 311 includes the first electrode portion (first portion) 351 and the second electrode portion (second portion) 352 in plan view. In plan view, the distance d2 between the second electrode portion 352 and the pixel region A1 is longer than the distance d1 between the first electrode portion 351 and the pixel region A1. In plan view, at least the first electrode portion 354 of the second peripheral electrode 312 is disposed between the pixel region A1 and the second electrode portion 352 of the first peripheral electrode 311.

In the liquid crystal device 10 according to the first embodiment, in the peripheral region A3 surrounding the plurality of pixel electrodes 120 of the pixel region A1 in plan view, the impurities IM having a negative polarity generated from the liquid crystal layer 140 of the pixel region A1 are first captured by the first electrode portion 351 disposed on the inner peripheral side in the first peripheral electrode 311 having a positive polarity. The impurities IM moving to the end portion of the first electrode portion 351 on the second electrode portion 352 side in the length direction are subjected to the repulsive effect from the second peripheral electrode 312 disposed between the second electrode portion 352 and the pixel region A1, are difficult to move along the circumferential direction as they are, are accumulated at the end portion of the first electrode portion 351, and move to the second electrode portion 352 disposed farther from the pixel region A1 than the first electrode portion 351 in plan view. Since the second peripheral electrode 312 having a negative polarity is disposed between the second electrode portion 352 having a positive polarity and the pixel region A1 in plan view, the impurities IM moved to the second electrode portion 352 are subjected to the repulsive effect from the second peripheral electrode 312, making it difficult for them to return to the pixel region A1 electrically and physically. The impurities IP generated from the liquid crystal layer 140 in pixel region A1, which have a positive polarity, are captured by the second peripheral electrode 312 having a negative polarity. Therefore, the capture of the impurities IM in the first electrode portion 351 in the energized state and the capture of the impurities IM in the second electrode portion 352 in the energized state or the non-energized state are efficiently promoted. As a result, according to the liquid crystal device 10 of the first embodiment, each of the first peripheral electrode 311 and the second peripheral electrode 312 can be disposed in the peripheral region A3 as described above based on the polarities of the impurities IM and IP, thereby suppressing the occurrence of display spots and display unevenness caused by the movement and local aggregation of the impurities IM and IP in the pixel region A1 and enhancing display quality and reliability.

In the liquid crystal device 10 according to the first embodiment, the first electrode portions 351 of the first peripheral electrode 311 and the first electrode portions 354 of the second peripheral electrode 312 are alternately disposed along the circumferential direction of the pixel region A1 in plan view.

In the liquid crystal device 10 according to the first embodiment, the impurities IM accumulated at both end portions of the first electrode portion 351 in the length direction are subjected to the repulsive effect from the second peripheral electrodes 312 adjacent to each other in the circumferential direction of the peripheral region A3 at each end portion, are difficult to move along the circumferential direction as they are, are accumulated at both end portions of the first electrode portion 351, and move to the second electrode portion 352 closest to each end portion in the circumferential direction of the peripheral region A3. The impurities IM moved to the second electrode portion 352 are subjected to the repulsive effect from the second peripheral electrode 312, making it difficult for them to return to the pixel region A1 electrically and physically. According to the liquid crystal device 10 of the first embodiment, it is possible to suppress the occurrence of display spots and display unevenness in the pixel region A1 in the entire circumferential direction and to enhance display quality and reliability.

In the liquid crystal device 10 according to the first embodiment, in plan view, the pixel region A1 has a rectangular shape, and the first electrode portion 351 of the first peripheral electrode 311 surrounds the corner portion (first corner portion) on the +X side and the +Y side of the pixel region A1. The first electrode portion 354 of the second peripheral electrode 312 surrounds the corner portion (second corner portion) on the −X side and the −Y side located at a diagonal of a corner portion on the +X side and the +Y side in plan view in the pixel region A1.

In the liquid crystal device 10 according to the first embodiment, the electrode portions 351A and 351C disposed on the +X side in the first peripheral electrode 311 are disposed to face the corner portion on the +X side and the +Y side of the movement direction destination of the impurities IM in the pixel region A1. In the second peripheral electrode 312, the electrode portions 354C and 354D, which are disposed on the −X side, are disposed to face the corner portion on the −X and −Y sides of the movement direction destination of the impurities IP in the pixel region A1. In the liquid crystal device 10 according to the first embodiment, when the impurities IM generated from the liquid crystal layer 140 of the pixel region A1 move toward the corner portion on the +X side and the +Y side in plan view, most of the impurities IM are efficiently captured by the electrode portions 351A and 351C of the first peripheral electrode 311. When the impurities IP generated from the liquid crystal layer 140 of the pixel region A1 move toward the corner portion on the −X side and the −Y side in plan view, most of the impurities IP are efficiently captured by the electrode portions 354C and 354D of the second peripheral electrode 312. According to the liquid crystal device 10 of the first embodiment, it is possible to efficiently suppress the occurrence of display spots and display unevenness in the pixel region A1 and to enhance display quality and reliability.

In the liquid crystal device 10 according to the first embodiment, the pixel region A1 has an oblong shape having long sides parallel to the X direction and short sides parallel to the Y direction in plan view. The electrode portions 351A and 351B of the first peripheral electrode 311 face the long side (one long side) of the pixel region A1 on the +Y side parallel to the X direction. The electrode portions 351A and 351C of the first peripheral electrode 311 surround the corner portions at both ends of the long side on the +Y side parallel to the X direction of the pixel region A1, that is, the corner portion on the +X side and the +Y side and the corner portion on the −X side and the +Y side.

In the liquid crystal device 10 according to the first embodiment, when the impurities IM generated from the liquid crystal layer 140 of the pixel region A1 mainly move toward the corner portion on the +X side and the +Y side in plan view, most of the impurities IM are efficiently captured by the electrode portions 351A and 351C disposed on the +X side of the first peripheral electrode 311, and the remaining part of the impurities IM are efficiently captured by the electrode portions 351A and 351C and the electrode portion 351B disposed on the −X side of the first peripheral electrode 311. According to the liquid crystal device 10 of the first embodiment, it is possible to efficiently suppress the occurrence of display spots and display unevenness in the pixel region A1 and to further enhance display quality and reliability.

In the liquid crystal device 10 according to the first embodiment, the first peripheral electrode 311 further includes the third electrode portion (third portion) 353, whose distance from the pixel region A1 is shorter than that of the second electrode portion 352 in plan view. The first electrode portion 354 of the second peripheral electrode 312 is disposed between the pixel region A1 and the electrode portion 353 in plan view, and is disposed between the pixel region A1 and the electrode portion 353 in the width direction of the peripheral region A3.

In the liquid crystal device 10 according to the first embodiment, the electrode portion 351 and the electrode portion 352 of the first peripheral electrode 311 that are adjacent to each other in the circumferential direction of the peripheral region A3, that is, in the length direction of each of the regions A31 to A34 of the peripheral region A3, can be coupled by the electrode portion 353. Accordingly, at least the first peripheral electrode 311 of the first and second peripheral electrodes 311 and 312 is coupled along the circumferential direction of the peripheral region A3 by the electrode portions 351, 352, and 353, thereby forming a single first electrode as a whole. According to the liquid crystal device 10 of the first embodiment, the first peripheral electrode 311 can be configured as an electrode coupled along the circumferential direction of the peripheral region A3 so as to suppress the number of coupling portions such as wirings and contact plugs coupled to the first peripheral electrode 311, reduce restrictions on the disposition of common wirings or conductive layers (not illustrated) formed on the element substrate 12, and simplify and streamline the manufacturing process.

In the liquid crystal device 10 according to the first embodiment, the second peripheral electrode 312 includes the first electrode portion (fourth portion) 354 and the second electrode portion (fifth portion) 355 in plan view. In plan view, the distance d2 between the second electrode portion 355 and the pixel region A1 is longer than the distance d1 between the first electrode portion 354 and the pixel region A1. In plan view, at least the first electrode portion 351 of the first peripheral electrode 311 is disposed between the pixel region A1 and the second electrode portion 355 of the second peripheral electrode 312.

In the liquid crystal device 10 according to the first embodiment, in the peripheral region A3, the impurities IP having a positive polarity generated from the liquid crystal layer 140 of the pixel region A1 are first captured by the first electrode portion 354 disposed on the inner peripheral side in the second peripheral electrode 312 having a negative polarity. The impurities IP moving to the end portion of the first electrode portion 354 on the second electrode portion 355 side in the length direction are subjected to the repulsive effect from the first peripheral electrode 311 disposed between the second electrode portion 355 and the pixel region A1, are difficult to move along the circumferential direction as they are, are accumulated at the end portion of the first electrode portion 354, and move to the second electrode portion 355 disposed farther from the pixel region A1 than the first electrode portion 354 in plan view. Since the first peripheral electrode 311 having a positive polarity is disposed between the second electrode portion 355 having a negative polarity and the pixel region A1 in plan view, the impurities IP moved to the second electrode portion 355 are subjected to the repulsive effect from the first peripheral electrode 311, making it difficult for them to return to the pixel region A1 electrically and physically. Therefore, the capture of the impurities IP in the first electrode portion 354 in the energized state and the capture of the impurities IP in the second electrode portion 355 in the energized state or the non-energized state are efficiently promoted. As a result, according to the liquid crystal device 10 of the first embodiment, each of the first peripheral electrode 311 and the second peripheral electrode 312 can be disposed in the peripheral region A3 as described above based on the polarities of the impurities IM and IP, thereby suppressing the occurrence of display spots and display unevenness caused by the movement and local aggregation of the impurities IM and IP in the pixel region A1 and enhancing display quality and reliability.

In the liquid crystal device 10 according to the first embodiment, in plan view, the electrode portions 354D and 354E of the second peripheral electrode 312 face the long side of the pixel region A1 on the −Y side parallel to the X direction. The electrode portions 354C and 354D of the second peripheral electrode 312 surround the corner portions at both ends of a long side on the −Y side parallel to the X direction of the pixel region A1, that is, the corner portion on the −X side and the −Y side and the corner portion on the +X side and the −Y side.

In the liquid crystal device 10 according to the first embodiment, when the impurities IP generated from the liquid crystal layer 140 of the pixel region A1 mainly move toward the corner portion on the −X side and the −Y side in plan view, most of the impurities IP are efficiently captured by the electrode portions 354C and 351D disposed on the −X side of the second peripheral electrode 312, and the remaining part of the impurities IP are efficiently captured by the electrode portions 354C and 354D and the electrode portion 351E disposed on the +X side of the second peripheral electrode 312. According to the liquid crystal device 10 of the first embodiment, it is possible to efficiently suppress the occurrence of display spots and display unevenness in the pixel region A1 and to further enhance display quality and reliability.

The electronic apparatus including the projector (electronic apparatus) 200 according to the first embodiment includes the liquid crystal device 10 described above.

According to the projector 200 and the electronic apparatus of the first embodiment, since they include the liquid crystal device 10, the display quality and reliability of the entire projected image can be enhanced.

### Second Embodiment

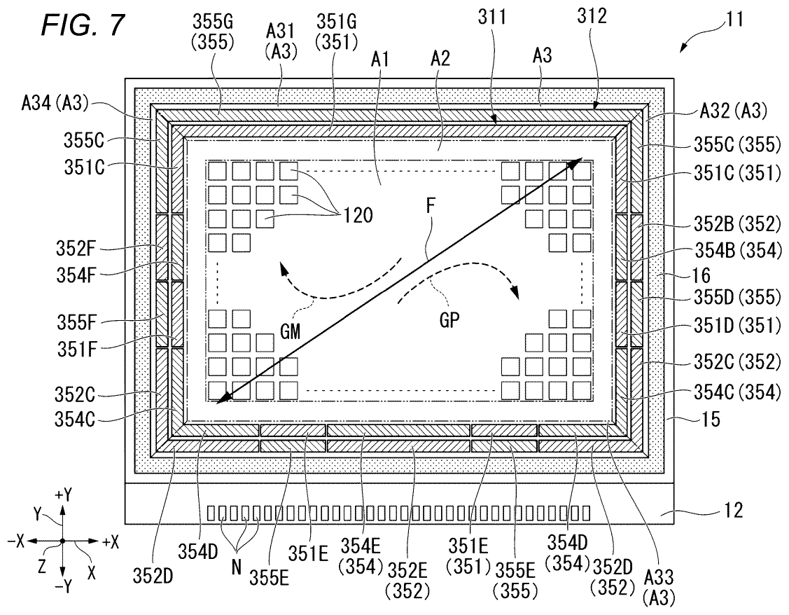

Next, a second embodiment of the present disclosure will be described with reference to FIG. 7. In the description of the second embodiment, the description of the contents in common with the first embodiment will be omitted, and only contents different from those in the first embodiment will be described. In addition, in the configuration of the liquid crystal device according to the second embodiment, the same reference numerals as those of the corresponding configuration in the liquid crystal device 10 according to the first embodiment are given to the configuration common to the liquid crystal device 10 according to the first embodiment, and the detailed description thereof will be omitted.

FIG. 7 is a plan view of a liquid crystal device 11. A liquid crystal device 11 according to the second embodiment has the same configuration as the liquid crystal device 10 according to the first embodiment. However, as illustrated in FIG. 7, in the liquid crystal device 11, a first electrode portion 351G of the first peripheral electrode 311 is disposed instead of the first electrode portions 351A and 351B of the first peripheral electrode 311 and the first electrode portion 354A of the second peripheral electrode 312 of the liquid crystal device 10. In addition, in the liquid crystal device 11, a second electrode portion 355G of the second peripheral electrode 312 is disposed instead of the second electrode portion 352A of the first peripheral electrode 311 and the second electrode portions 355A and 355B of the second peripheral electrode 312 of the liquid crystal device 10.

The +X side end of the electrode portion 351G is coupled to the +Y side end of the electrode portion 351C disposed on the +X side. The −X side end of the electrode portion 351G is coupled to the +Y side end of the electrode portion 351C disposed on the −X side. In plan view, at the corner portion on the +X side and the +Y side of the pixel region A1, the electrode portion 351C disposed on the +X side, and the +X side end of the electrode portion 351G face each other. At the corner portion on the −X side and the +Y side of the pixel region A1, the electrode portion 351C disposed on the −X side and the −X side end of the electrode portion 351G face each other.

In the liquid crystal device 11, the first electrode portion 351G of the first peripheral electrode 311 is disposed without a gap along the X direction between the end on the −X side and the end on the +X side in the region on the inner peripheral side of the region A31. In the region on the outer peripheral side of the region A31, the second electrode portion 355G of the second peripheral electrode 312 is disposed without a gap along the X direction between the end on the −X side and the end on the +X side. The size in the Y direction, that is, the width dimension of the electrode portion 351G is larger than the size in the Y direction, that is, the width dimension of the electrode portion 355G, and is equal to the size in the Y direction, that is, the width dimension of the first electrode portion 351 including the electrode portion 351C.

Similarly to the liquid crystal device 10 according to the first embodiment, the liquid crystal device 11 according to the second embodiment described above includes the counter electrode (common electrode) 150, the plurality of pixel electrodes 120, the first peripheral electrode (first electrode) 311, the second peripheral electrode (second electrode) 312, and the liquid crystal layer 140. According to the liquid crystal device 11 according to the second embodiment, the same effects and advantages as those of the liquid crystal device 10 of the first embodiment are obtained.

In the liquid crystal device 11 according to the second embodiment, one electrode portion 351G of the first peripheral electrode 311 faces the long side of the pixel region A1 on the +Y side parallel to the X direction, and one electrode portion 355G of the second peripheral electrode 312 is disposed on the +Y side of the electrode portion 351G. According to the liquid crystal device 11 of the second embodiment, the number of coupling portions such as wirings and contact plugs coupled to the first peripheral electrode 311 can be further reduced, thereby reducing restrictions on the disposition of source lines of the TFT (not illustrated) formed on the element substrate 12, as well as various common wirings and conductive layers, and further contributing to the simplification and streamlining of the manufacturing process.

Specifically, it has been found that the moving speed of the impurities IM generated from the liquid crystal layer 140 in the pixel region A1 is slower than the moving speed of the impurities IP generated from the liquid crystal layer 140. At least a part of the impurities IP moves to the peripheral portion forming the long side on the +Y side of the pixel region A1, which is parallel to the X direction, and is captured by the first electrode portion 351G of the first peripheral electrode 311. As described above, since the moving speed of the impurities IM is slower than that of the impurities IP, the impurities IM captured by the electrode portion 351G easily move to the +Y side along the Y direction rather than along the X direction.

In the liquid crystal device 11 according to the second embodiment, the electrode portion 351G of the first peripheral electrode 311 that captures the impurities IM with relatively slow moving speed faces each of the corner portion on the +X side and the +Y side, the corner portion on the −X side and the +Y side, and the peripheral portion on the +Y side parallel to the X direction of the pixel region A1, which is the movement destination of the impurities IM, and is disposed to be coupled along the circumferential direction of the peripheral region A3. The electrode portion 355G of the second peripheral electrode 312 is disposed in the peripheral region A3 so as to face the electrode portion 351G from the outer peripheral side. The width dimension of the electrode portion 351G is larger than the width dimension of the electrode portion 355G. In the liquid crystal device 11 according to the second embodiment, the impurities IM with relatively slow moving speed are captured by the electrode portion 351G, the impurities IM are allowed to spread to the +Y side to some extent and the repulsive effect of the impurities IM from the electrode portion 355G is exerted, and the movement of the impurities IM on the +Y side and the movement in the X direction in the electrode portion 351G are favorably dispersed, and thus the capturing effect of the impurities IM can be improved as compared with the liquid crystal device 10 according to the first embodiment.

Preferable embodiments of the present disclosure have been described above in detail. The present disclosure is, however, not limited to a specific embodiment, and a variety of modifications and changes can be made to the embodiments within the scope of the substance of the present disclosure described in the claims.

For example, in the cross-sectional view of the liquid crystal device or the like, the stacked structure including the conductive layer, semiconductor layer, or insulating layer within each of the element substrate 12 and the counter substrate 15 is omitted, and an example of the conductive layer is illustrated. A conductive layer, a semiconductor layer, or an insulating layer (not illustrated), for wiring or interlayer spacing, may be provided between the +Z side surface of the element substrate 12 and at least one of the pixel electrode 120, the dummy pixel electrode 122, the first peripheral electrode 311, and the second peripheral electrode 312. The −Z side surface of at least one of the pixel electrode 120, the dummy pixel electrode 122, the first peripheral electrode 311, and the second peripheral electrode 312 may not be a flat surface.

For example, in each of the liquid crystal device 10 according to the first embodiment and the liquid crystal device 11 according to the second embodiment, fine unevenness may be formed on the +Z side surfaces of the electrode portions 351, 352, and 353 of the first peripheral electrode 311, and fine unevenness may be formed on the +Z side surface of the electrode portions 354 and 355 of the second peripheral electrode 312.

### SUMMARY OF PRESENT DISCLOSURE

The following is provided as a summary of the present disclosure.

(Appendix 1) A liquid crystal device including: a common electrode to which a common potential is applied; a plurality of pixel electrodes to each of which a signal potential is applied and which are disposed in a display region; a first electrode to which a first potential having a positive polarity with respect to the common potential is applied and which is disposed in a part of a peripheral region surrounding the display region in plan view; a second electrode to which a second potential having a negative polarity with respect to
the common potential is applied and which is disposed in a part of the peripheral region in plan view; and a liquid crystal layer disposed between each of the plurality of pixel electrodes and the common electrode, between the first electrode and the common electrode, and between the second electrode and the common electrode; wherein the first electrode includes a first portion and a second portion having a longer distance from the display region than the first portion in plan view, and the second electrode is disposed between the display region and the second portion in plan view.

According to the configuration of Appendix 1,when the impurities having a negative polarity are generated from the liquid crystal layer in the display region, the capture of the impurities having a negative polarity in the first portion of the first electrode in the energized state and the capture of the impurities having a negative polarity in the second portion in the energized state or the non-energized state are efficiently promoted. As a result, according to the configuration of Appendix 1, each of the first and second electrodes can be disposed as peripheral electrodes based on the polarity of the impurities, thereby suppressing the occurrence of display spots and display unevenness caused by the movement and local aggregation of impurities having a negative polarity in the display region, and enhancing the display quality and reliability of the liquid crystal device.

(Appendix 2) The liquid crystal device according to Appendix 1, wherein the first portion and the second electrode are alternately disposed along the circumferential direction of the display region in plan view.

According to the configuration of Appendix 2, by applying the repulsive effect from the second electrode to the impurities that moved to the second portion of the first electrode, it is possible to make it difficult for the impurities to electrically and physically return to the display region, thereby suppressing the occurrence of display spots and display unevenness throughout the entire circumferential direction of the display region and enhancing the display quality and reliability of the liquid crystal device.

(Appendix 3) The liquid crystal device according to Appendix 1 or 2, wherein, in plan view, the display region has a rectangular shape, the first portion surrounds a first corner portion of the display region, and the second electrode surrounds a second corner portion at a position diagonal to the first corner portion in the display region.

In the configuration of Appendix 3, when the impurities generated from the liquid crystal layer in the display region move toward the first corner portion in plan view, most of the impurities are efficiently captured by the first portion of the first peripheral electrode. When impurities having a polarity different from that of the above-described impurities, which are generated from the liquid crystal layer of the display region, move toward the second corner portion in plan view, most of the impurities having a polarity different from that of the above-described impurities are efficiently captured by the second peripheral electrode. According to the configuration of Appendix 3, it is possible to efficiently suppress the occurrence of display spots and display unevenness in the display region, and to enhance the display quality and reliability of the liquid crystal device.

(Appendix 4) The liquid crystal device according to any one of Appendices 1 to 3, wherein, in plan view, the display region has an oblong shape, and the first portion faces one long side of the display region and surrounds the corner portions at both ends of the long side.

In the configuration of Appendix 4, when the impurities IM generated from the liquid crystal layer 140 of the pixel region A1 mainly move toward one of the corner portions at both ends of the long side in plan view, a part of the impurities is efficiently captured by the first portion of the first electrode facing the other corner portion of the corner portions at both ends of the long side. According to the configuration of Appendix 4, it is possible to efficiently suppress the occurrence of display spots and display unevenness in the display region, and to further enhance the display quality and reliability of the liquid crystal device.

(Appendix 5) The liquid crystal device according to any one of Appendices 1 to 4, wherein the first electrode further includes a third portion having a shorter distance from the display region than that of the second portion, and the second electrode is disposed between the display region and the third portion.

According to the configuration of Appendix 5, the first electrode can be configured as a single electrode coupled along the circumferential direction of the peripheral region, thereby suppressing the number of coupling portions such as wirings or contact plugs coupled to the first electrode, reducing restrictions on the disposition of common wirings or conductive layers, and enabling simplification of the stacked structure of the liquid crystal device and streamlining of the manufacturing process.

(Appendix 6) The liquid crystal device according to any one of Appendices 1 to 5, wherein the second electrode includes a fourth portion and a fifth portion having a longer distance from the display region than that of the first portion in plan view, and the first portion is disposed between the display region and the fifth portion in plan view.

According to the configuration of Appendix 6, when the impurities having a positive polarity are generated from the liquid crystal layer in the display region, the capture of the impurities having a positive polarity in the fourth portion of the second electrode in the energized state and the capture of the impurities having a positive polarity in the fifth portion in the energized state or the non-energized state are efficiently promoted. As a result, according to the configuration of Appendix 6, each of the first and second electrodes can be disposed as peripheral electrodes based on the polarity of the impurities, thereby suppressing the occurrence of display spots and display unevenness caused by each movement and local aggregation of impurities having a negative polarity, in addition to those of impurities having a positive polarity in the display region, and further enhancing the display quality and reliability of the liquid crystal device.

(Appendix 7) An electronic apparatus including the liquid crystal device according to any one of Appendices 1 to 6.

According to the configuration of Appendix 7, the display quality of the output image of the electronic apparatus and the reliability of the electronic apparatus can be enhanced.

What is claimed is:

1. A liquid crystal device comprising:
a common electrode to which a common potential is applied;
a pixel electrode to which a signal potential is applied and which is disposed in a display region;
a first electrode to which a first potential having a positive polarity with respect to the common potential is applied and which is disposed outside the display region in plan view;
a second electrode to which a second potential having a negative polarity with respect to the common potential is applied and which is disposed outside the display region in plan view; and
a liquid crystal layer disposed between the pixel electrode and the common electrode, between the first electrode and the common electrode, and between the second electrode and the common electrode;
wherein the first electrode comprises a first portion and a second portion having a longer distance from the display region than the first portion in plan view, and
wherein the second electrode is disposed between the display region and the second portion in plan view.

2. The liquid crystal device according to claim 1, wherein the first portion and the second electrode are alternately disposed along a circumferential direction of the display region in plan view.

3. The liquid crystal device according to claim 1, wherein, in plan view, the display region has a rectangular shape, the first portion surrounds a first corner portion of the display region, and the second electrode surrounds a second corner portion of the display region at a position diagonal to the first corner portion in the display region.

4. The liquid crystal device according to claim 1, wherein, in plan view, the display region has an oblong shape, and the first portion faces one long side of the display region and surrounds corner portions of the display region at both ends of the long side.

5. The liquid crystal device according to claim 1, wherein the first electrode further includes a third portion having a shorter distance from the display region than that of the second portion, and the second electrode is disposed between the display region and the third portion.

6. The liquid crystal device according to claim 1, wherein the second electrode includes a fourth portion and a fifth portion having a longer distance from the display region than that of the fourth portion in plan view, and the first portion is disposed between the display region and the fifth portion in plan view.

7. An electronic apparatus comprising the liquid crystal device according to claim 1.
